(19) United States
(12) Patent Application Publication
(10) Pub. No.: US 2023/0332753 A1
(43) Pub. Date: Oct. 19, 2023

(54) SOUND-SENSITIVE COLOR CHANGING NIGHTLIGHT

(71) Applicant: Mary Elle Fashions, Inc., St.. Louis, MO (US)

(72) Inventors: Kenneth A. Howard, Creve Coeur, MO (US); Matthew S. Smith, St. Charles, MO (US)

(21) Appl. No.: 18/135,989

(22) Filed: Apr. 18, 2023

Related U.S. Application Data
(60) Provisional application No. 63/332,253, filed on Apr. 18, 2022.

(51) Int. Cl. F21S 8/00; H05B 45/20; H05B 47/12

(52) U.S. Cl. CPC F21S 8/035; H05B 45/20; H05B 47/12; F21Y 2115/10

(57) ABSTRACT

A nightlight including a base and an electrical prong secured to the base and adapted to be inserted into an electrical outlet is disclosed. A main circuit is coupled to the electrical prong and contained within the base. A plurality of light sources provide different colors of light in a visible light spectrum and a lens is secured to the base and positioned adjacent to the light sources. A sound transducer produces an electrical signal as a function of ambient sound and the main circuit is coupled to the sound transducer and the light sources for varying the color of light in the visible light spectrum that is produced by the light sources as a function of the ambient sound. The light sources may include light emitting diodes and laser diodes. The lens may include an image or cut-out positioned thereon so that the light sources project a pattern of light as a function of the image or cut-out. The main circuit may vary the color and intensity of the light that is produced by the light sources as a function of the ambient sound. The nightlight may have at least 5 LEDs or laser diodes but not more than 1,000 LEDs or laser diodes.

### CROSS-REFERENCE TO RELATED APPLICATIONS

This application claims the benefit of U.S. Provisional Patent Application Ser. No. 63/332,253 filed Apr. 18, 2022. The entire contents of the above application are hereby incorporated by reference.

### FIELD OF THE INVENTION

The present disclosure relates to a nightlight for illuminating an area adjacent thereto with multi-colored light as a function of ambient sound.

### BACKGROUND OF THE INVENTION

Traditional nightlights have used low power incandescent bulbs or LEDs to provide a low level of typically yellow or white light adjacent thereto. Some nightlights have incorporated images or cut-outs to display a pattern on an adjacent wall. Other nightlights have incorporated colored lights to display or illuminate with various selected colors. Nightlights may be activated with a manual switch or a light sensitive switch that is activated when the ambient light level falls below a preset level.

### SUMMARY OF THE INVENTION

As described more fully below, embodiments may include a nightlight with a base and an electrical prong secured to the base and adapted to be inserted into an electrical outlet. A main circuit is coupled to the electrical prong and contained within the base. A plurality of light sources provide different colors of light in a visible light spectrum and a lens is secured to the base and positioned adjacent to the light sources. The nightlight includes a sound transducer to produce an electrical signal as a function of ambient sound. The main circuit is coupled to the sound transducer and the light sources for varying the color of light in the visible light spectrum that is produced by the light sources as a function of the ambient sound. The light sources may include light emitting diodes and laser diodes. The lens may include an image or cut-out positioned thereon so that the light sources project a pattern of light as a function of the image or cut-out. The main circuit may vary the color and intensity of the light that is produced by the light sources as a function of the ambient sound. The nightlight may have at least 5 LEDs or laser diodes but not more than 1,000 LEDs or laser diodes.

Other features will be in part apparent and in part pointed out hereinafter.

### BRIEF DESCRIPTION OF THE DRAWINGS

FIG. 1 shows a nightlight containing multiple LEDs, laser diodes, or other sources of colorful light.

FIG. 2 shows a schematic diagram of circuitry to control multiple light sources.

Corresponding reference characters indicate corresponding parts throughout the drawings.

### DETAILED DESCRIPTION

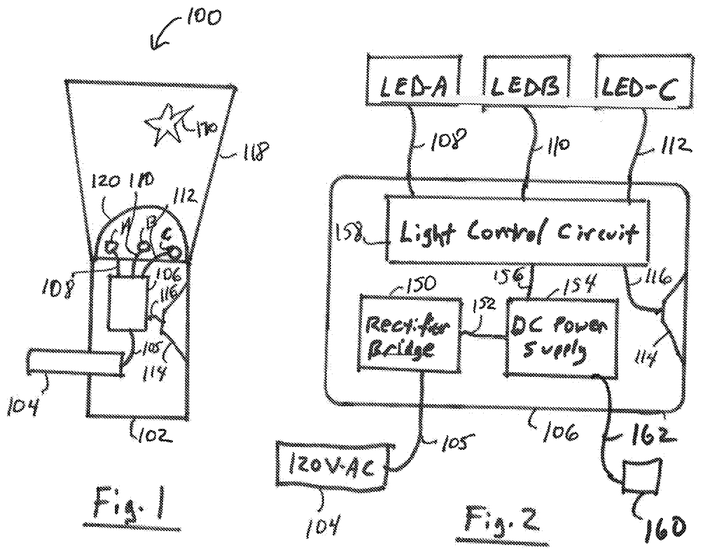

FIG. 1 shows a nightlight 100 that includes a plurality of colorful light sources such as LEDs A, B and C shown there. LEDs A, B and C may be red, green and blue LEDs, respectively, or may be sized and structured to provide any preferred color and intensity of light. For example, as is known in the art, multiple LEDs may be located adjacent each other to provide light mixing to thereby provide many of the colors in the visible spectrum. Many more than three LEDs may be used within the scope of the invention depending on the preferences of the designer. For example, nightlight 100 may include at least 5 LEDs, at least 10 LEDs, or at least 50 LEDs but likely not more than 1,000 LEDs or not more than 500 LEDs or not more than 100 LEDs. In the alternative to and in place of LEDs A, B and C shown in the nightlight of FIG. 1, a person of skill in the art might use colorful laser diodes, combinations of laser diodes with colorful reflectors or filters, or any other common light source or combination of a common light source with colorful reflectors or filters. For example, nightlight 100 may include at least 5 laser diodes, at least 10 laser diodes, or at least 50 laser diodes but likely not more than 1,000 laser diodes or not more than 500 laser diodes or not more than 100 laser diodes.

Nightlight 100 includes a base 102 that supports conventional electrical prongs 104 sized for insertion into a standard electrical outlet that provides nominal 120 volt AC electricity. A conductor 105 provides the electrical power to a main circuit 106. The main circuit 106 includes conductors 108, 110 and 112 for selectively energizing LEDs A, B and C. Nightlight 100 also includes a sound transducer or microphone 114 that creates an electrical signal in response to ambient sound. This electrical signal is provided to main circuit 106 via conductor 116. Nightlight 100 may include a shade or lens 118 and may also include an additional shade or lens 120 for dispersing light. Multiple shades may be preferable when the light produced by LEDs A, B and C is highly concentrated in a sharp beam. Likewise, when laser diodes are used in place of LEDs A, B and C, multiple shades may be particularly preferred.

In use, the main circuit 106 may receive a signal from sound transducer 114 and, in response thereto, vary the electricity provided to LEDs A, B and C to vary the color of the light output by the nightlight 100 as a function of the ambient sound. In use, the main circuit 106 may receive a signal from sound transducer 114 and, in response thereto, vary the electricity provided to LEDs A, B and C to vary the intensity of the light or the intensity of the color of the light output by the nightlight 100 as a function of the ambient sound. In use, the main circuit 106 may receive a signal from sound transducer 114 and, in response thereto, vary the electricity provided to LEDs A, B and C to vary the color and intensity of the light output by the nightlight 100 as a function of the ambient sound.

The shade or lens 118 or 120 of nightlight 100 may include an image or cut-out 170 to project a pattern corresponding to the image or cut-out 170 on an adjacent wall.

FIG. 2 is a schematic diagram for the main circuit 106. As seen, main circuit 106 is connected to conventional electrical prongs 104 sized for insertion into a standard electrical outlet that provides nominal 120 volt AC electricity. A rectifier bridge 150 provides a DC voltage. The rectifier bridge 150 may be a full bridge or a partial bridge, as known to those skilled in the art. The DC voltage is carried by a conductor 152 to a DC power supply 154 that supplies a light control circuit 158 with an appropriate level of DC voltage. DC power supply may preferably include a capacitor (not shown) to smooth out the DC wave form. The light control circuit 158 is connected to the sound transducer or microphone 114 via conductor 116. The light control circuit 158 controls LEDs A, B and C, respectively, via conductors 108, 110 and 112.

FIG. 2 also includes a switch 160 coupled to the main circuit 106 via a conductor 162. Switch 160 may be a conventional manual switch or a switch that operates as a function of the level of the ambient light. Switch 160 turns nightlight 100 ON and OFF. Switch 160 is preferably coupled to the DC power supply 154; however, a person of skill in the art could also control the ON/OFF function of nightlight 100 by coupling switch 160 to the rectifier bridge 150, to the light control circuit 158, or between the rectifier bridge 150 and the electrical prongs 104.

In use, the light control circuit 158 may receive a signal from sound transducer 114 and, in response thereto, vary the electricity provided to LEDs A, B and C to vary the color of the light output by the nightlight 100 as a function of the ambient sound. In use, the light control circuit 158 may receive a signal from sound transducer 114 and, in response thereto, vary the electricity provided to LEDs A, B and C to vary the intensity of the light or the intensity of the color of the light output by the nightlight 100 as a function of the ambient sound. In use, the light control circuit 158 may receive a signal from sound transducer 114 and, in response thereto, vary the electricity provided to LEDs A, B and C to vary the color and intensity of the light output by the nightlight 100 as a function of the ambient sound.

LEDs A, B and C in FIG. 2 may be red, green and blue LEDs, respectively, or may be sized and structured to provide any preferred color and intensity of light. For example, as is known in the art, multiple LEDs may be located adjacent each other to provide light mixing to thereby provide many of the colors in the visible spectrum. Many more than three LEDs may be used within the scope of the invention depending on the preferences of the designer. For example, nightlight 100 may include at least 5 LEDs, at least 10 LEDs, or at least 50 LEDs but likely not more than 1,000 LEDs or not more than 500 LEDs or not more than 100 LEDs. In the alternative to and in place of LEDs A, B and C shown in FIG. 2, a person of skill in the art might use colorful laser diodes, combinations of laser diodes with colorful reflectors or filters, or any other common light source or combination of a common light source with colorful reflectors or filters. For example, nightlight 100 may include at least 5 laser diodes, at least 10 laser diodes, or at least 50 laser diodes but likely not more than 1,000 laser diodes or not more than 500 laser diodes or not more than 100 laser diodes.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A nightlight comprising:
a base;
an electrical prong adapted to be inserted into an electrical outlet, wherein the electrical prong is secured to and projects from the base;
a main circuit coupled to the electrical prong and contained within the base;
a plurality of light sources providing different colors of light in a visible light spectrum and secured to the base;
a lens secured to the base and positioned adjacent to the light sources;
a sound transducer for producing an electrical signal as a function of an ambient sound; and
wherein the main circuit is coupled to the sound transducer and the light sources for varying the color of light in the visible light spectrum that is produced by the light sources as a function of the ambient sound.

2. The nightlight of claim 1 wherein the light sources comprise light emitting diodes.

3. The nightlight of claim 1 wherein the lens comprises an image or cut-out positioned thereon, wherein the light sources are adapted to project a pattern of light as a function of the image or cut-out.

4. The nightlight of claim 1 further comprising a plurality of lenses mounted to the base adjacent the light sources.

5. The nightlight of claim 1 wherein the sound transducer comprises a microphone for producing the electrical signal as a function of the ambient sound.

6. The nightlight of claim 1 wherein the main circuit is adapted to vary the color of light and an intensity of the light that is produced by the light sources as a function of the ambient sound.

7. The nightlight of claim 1 wherein the light sources comprise at least 5 LEDs but not more than 1,000 LEDs.

8. The nightlight of claim 1 wherein the light sources comprise at least 10 LEDs but not more than 500 LEDs.

9. The nightlight of claim 1 wherein the light sources comprise laser diodes.

10. The nightlight of claim 9 wherein the lens comprises an image or cut-out positioned thereon, wherein the light sources are adapted to project a pattern of light as a function of the image or cut-out.

11. The nightlight of claim 9 further comprising a plurality of lenses mounted to the base adjacent the light sources.

12. The nightlight of claim 9 wherein the sound transducer comprises a microphone for producing the electrical signal as a function of the ambient sound.

13. The nightlight of claim 9 wherein the main circuit is adapted to vary the color of light and an intensity of the light that is produced by the light sources as a function of the ambient sound.

14. The nightlight of claim 9 wherein the light sources comprise at least 5 laser diodes but not more than 1,000 laser diodes.

15. The nightlight of claim 9 wherein the light sources comprise at least 10 laser diodes but not more than 500 laser diodes.

16. The nightlight of claim 2 wherein the lens comprises an image or cut-out positioned thereon, wherein the light sources are adapted to project a pattern of light as a function of the image or cut-out; and the nightlight further comprises a plurality of lenses mounted to the base adjacent the light sources.

17. The nightlight of claim 16 wherein the sound transducer comprises a microphone for producing the electrical signal as a function of the ambient sound; and
the main circuit is adapted to vary the color of light and an intensity of the light that is produced by the light sources as a function of the ambient sound.

18. The nightlight of claim 17 wherein the light sources comprise at least 5 LEDs but not more than 1,000 LEDs.

19. The nightlight of claim 9 wherein the lens comprises an image or cut-out positioned thereon, wherein the light sources are adapted to project a pattern of light as a function of the image or cut-out; and the nightlight further comprises a plurality of lenses mounted to the base adjacent the light sources.

20. The nightlight of claim 19 wherein the sound transducer comprises a microphone for producing the electrical signal as a function of the ambient sound; and the main circuit is adapted to vary the color of light and an intensity of the light that is produced by the light sources as a function of the ambient sound.
